(19) United States
(12) Patent Application Publication
(10) Pub. No.: US 2014/0172179 A1
(43) Pub. Date: Jun. 19, 2014

(54) SYSTEM AND METHOD FOR DISPENSING FUEL

(71) Applicant: Shell Oil Company, Houston, TX (US)

(72) Inventors: Earl Joseph BAUDIN, JR., Houston, TX (US); Dipesh Praful PATEL, Katy, TX (US); Brian Hale RICHARDS, Chicago, IL (US)

(73) Assignee: Shell Oil Company, Houston, TX (US)

(21) Appl. No.: 14/107,929

(22) Filed: Dec. 16, 2013

Related U.S. Application Data
(60) Provisional application No. 61/739,368, filed on Dec. 19, 2012.

(51) Int. Cl. G05D 7/06

(52) U.S. Cl. CPC G05D 7/0629
USPC 700/283

(57) ABSTRACT

A system for dispensing fuel may include a fuel dispenser and a server configured to communicate directly with a plurality of fuel dispensers that are remote from one another. The fuel dispenser may include a housing, a fuel dispensing apparatus mounted in the housing, a controller operatively coupled to the fuel dispensing apparatus, a nozzle operatively coupled to the fuel dispensing apparatus and the controller, and an interface operatively coupled to the controller and configured to receive information from the server. Responsive to information received from the server at the interface, the controller may selectively permit the dispensing of fuel through the nozzle.

This application claims the benefit of U.S. Provisional Application No. 61/739,368, filed Dec. 19, 2012, the disclosure of which is incorporated by reference herein in its entirety.

### FIELD OF THE INVENTION

The invention relates to a system and method for dispensing fuel.

### BACKGROUND

In recent years, fuel dispensers have become more than a means for fueling a vehicle. Service stations provide an increasing number of services at the fuel dispenser, including advertising, rebates, discounts, loyalty program benefits, and the like. Additionally, some fuel dispensers facilitate ordering other onsite services, such as car washes. Many fuel dispensers include card readers allowing payment for fuel and/or other services or products. As the amount of information and variety of products and services provided to the consumer increases, the number of ways to present relevant information to the customer also increases.

A typical fuel dispensing system includes multiple fuel dispensers each having two fueling positions, and a central site controller. Sophisticated dispenser systems incorporate expensive, hardware-intensive controllers in each fuel dispenser. Some fuel dispensers include a display and touch pad (or screen) to order goods or services or to provide messaging. Generally, changing the various options or presentations involves changing firmware or downloading new software to each dispenser. With any software application, revisions are necessary and when revisions are made, every dispenser at every desired location must be upgraded. Thus, even small changes can be time consuming and expensive.

As fuel dispensers get more interactive, the trend is to increase the computational ability within each dispenser as additional functionality is desired. The cost to upgrade each fuel dispenser with the computational horsepower to fully realize multimedia applications or other customization is often prohibitive, and providing customized software for each upgraded fuel dispenser involves significant cost and manpower. Further, it may take months to upgrade the fuel dispensers to incorporate a desired change. Because of the length of time for development to move from concept to full integration, a new upgrade to the fuel dispensers is frequently desired before the preceding upgrade has even been fully integrated.

### SUMMARY OF THE INVENTION

In accordance with one embodiment, a fuel dispenser includes a housing, a fuel dispensing apparatus mounted in the housing, a controller operatively coupled to the fuel dispensing apparatus, a nozzle operatively coupled to the fuel dispensing apparatus and the controller, and an interface operatively coupled to the controller and configured to receive information from a server configured to communicate directly with a plurality of fuel dispensers that are remote from one another. Responsive to information received from the server at the interface, the controller may selectively permit the dispensing of fuel through the nozzle.

In accordance with an embodiment, a system for dispensing fuel includes a fuel dispenser and a server configured to communicate directly with a plurality of fuel dispensers that are remote from one another. The fuel dispenser may include a housing, a fuel dispensing apparatus mounted in the housing, a controller operatively coupled to the fuel dispensing apparatus, a nozzle operatively coupled to the fuel dispensing apparatus and the controller, and an interface operatively coupled to the controller and configured to receive information from the server. Responsive to information received from the server at the interface, the controller may selectively permit the dispensing of fuel through the nozzle.

In accordance with one embodiment, a method of dispensing fuel includes receiving, at a server configured to communicate directly with a plurality of fuel dispensers that are remote from one another, a message including a customer identifier and fuel dispenser identifier for a particular one of the plurality of fuel dispensers, determining, based on the customer identifier, whether payment is approved, and responsive to a determination that payment is approved, transmitting a message from the server to the particular fuel dispenser instructing the particular fuel dispenser to dispense fuel.

### BRIEF DESCRIPTION OF THE FIGURES

FIG. 1 is a schematic of a fuel dispensing system incorporating a server remote from a fuel dispenser.

FIG. 2 is a schematic of one embodiment of architecture of the system of FIG. 1.

FIG. 3 is a schematic of one embodiment of architecture of the system of FIG. 1.

FIG. 4 is a schematic of one embodiment of architecture of the system of FIG. 1.

### DETAILED DESCRIPTION

Conventional fuel dispensing systems have increasingly complex software onsite. Thus, adding additional functionality involves changes at the site. An improved fuel dispensing system removes the onsite server and replaces it with a server remote from the fuel dispenser. That remote server can interact with fuel dispensers at multiple sites, allowing software upgrades to be made at a centralized location, providing improved timing, reduced manpower, and reduced cost for updates. An upgrade to an onsite server might influence several fuel dispensers at that site, but still requires a technician to visit the site and spend the time upgrading the server. If many sites need to be upgraded, multiple technicians may spend quite a long time visiting each of the sites and providing the upgrade. In the improved system, however, an upgrade to the remote server may instantaneously have an impact on fuel dispensers at any number of sites in communication with the server. Thus, the time, manpower, and expense associated with upgrading and maintaining multiple onsite servers can be reduced. Additional advantages will be apparent from the description below.

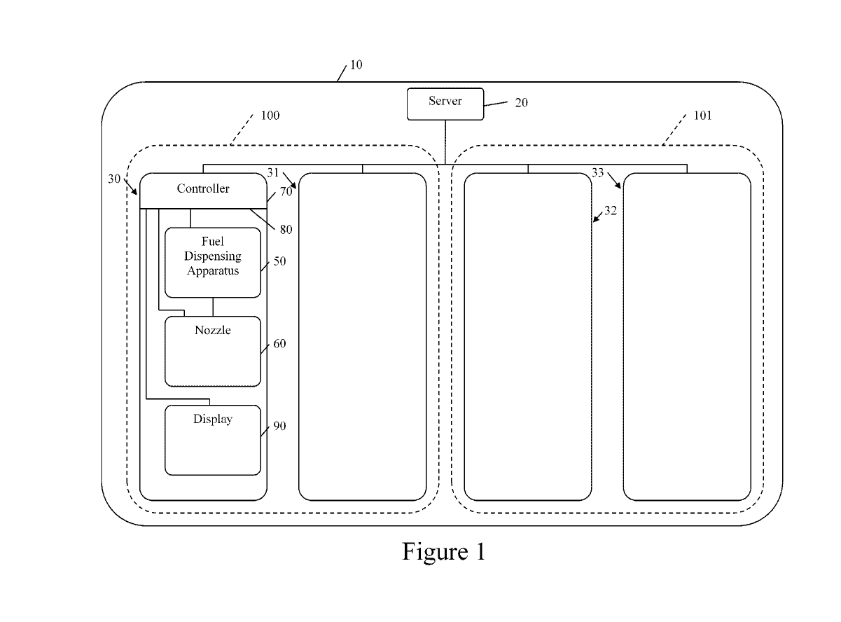

Referring to FIG. 1, a system 10 for dispensing fuel (e.g., gasoline or diesel products) may include a server 20 and a fuel dispenser 30. The server 20 may be configured to communicate directly with the fuel dispenser 30 along with at least one other fuel dispenser 31 such that the server 20 can communicate directly with at least two of a plurality of fuel dispensers (e.g., 30, 31, 32, etc.) that are remote from one another (i.e., not at the same site). While multiple fuel dispensers may be at any given site (e.g., fuel dispensers 30 and 31 at site 100), the server 20 should be configured to communicate directly with at least one fuel dispenser at each of at least two different sites (e.g., sites 100 and 101), preferably multiple fuel dispensers at multiple different sites (e.g., fuel dispensers 30 and 31 at site 100 and fuel dispensers 32 and 33 at site 101). The server may be remote from any or all of the plurality of fuel dispensers. The communications between the server 20 and the plurality of fuel dispensers may be in a single direction or in multiple directions. Thus, the server 20 may be configured to transmit information directly to the plurality of fuel dispensers, to receive information from the plurality of fuel dispensers, or both. Further, information received from the plurality of fuel dispensers may be either directly transmitted or indirectly transmitted to the server 20 as described further below.

Each of the plurality of fuel dispensers may have different features or each may have features similar to the features of the fuel dispenser 30 as described below. The fuel dispenser 30 may have a housing 40, a fuel dispensing apparatus 50 mounted in the housing, and a nozzle 60 also mounted in the housing 40. The fuel dispenser 30 may also include a controller 70 operatively coupled to the fuel dispensing apparatus 50. The nozzle 60 may be operatively coupled to the fuel dispensing apparatus 50 and to the controller 70. The fuel dispenser 30 may include an interface 80 operatively coupled to the controller 70 and configured to receive information from the server 20. The configuration of the fuel dispenser 30 may be such that, responsive to information received from the server 20 at the interface 80, the controller 70 selectively permits the dispensing of fuel through the nozzle 60. Thus, the server 20 may provide instruction to the controller 70 via the interface 80 to release the nozzle 60 for fueling. The controller 70 may be remote from the fuel dispenser 30 while remaining operatively coupled to the fuel dispenser 30. Thus, one controller may be operatively coupled to a plurality of fuel dispensers at multiple sites Similarly, one controller may be operatively coupled to a plurality of fuel dispensers at a particular site.

The fuel dispenser 30 may also include a display 90 mounted in the housing 40 and operatively coupled to the controller 70 such that, responsive to the receipt of information from the server 20 at the interface 80, a message is shown on the display 90. The message may be any kind of communication to the customer. The message may include an indication of approval of the transaction, discounted fuel price, a social media message, a special offer, etc. Likewise, the message may not be specific to the customer, but may be a mass message, a regional message, w wholesaler message, a service station message, or even a message specific to the fuel dispenser 30. Messaging may be delivered at pre fueling, fueling, or post fueling stages in the transaction, and may be varied depending upon the capabilities of the fuel dispenser 30 (e.g., screen size, resolution, color capabilities, etc.).

A method of dispensing fuel may use the system 10 described above, or another similar system. The method may include of receiving, at the server 20 configured to communicate directly with a plurality of fuel dispensers that are remote from one another, a message including a customer identifier and a fuel dispenser identifier for a particular one of the fuel dispensers (e.g., fuel dispenser 30). The method may also include determining, based on the customer identifier, whether payment is approved, and responsive to a determination that payment is approved, transmitting a message from the server to the particular fuel dispenser instructing the particular fuel dispenser to dispense fuel. The message received at the server may be transmitted by the particular fuel dispenser in response to the customer providing an indication of the customer identifier. Alternatively, the message received at the server may be transmitted by an external interface 300, such as the customer's cellular network, a wireless internet connection, or other interface, in response to the customer obtaining a fuel dispenser identifier or otherwise interacting with the particular fuel dispenser. Determining whether payment is approved may include receiving, at the server 20, an indication from a payment processing center 22 whether payment is approved. Receiving the indication that payment is approved may occur in response to transmitting an inquiry to the payment processing center 22 from the server 20 an inquiry as to whether payment is approved.

The method may include determining whether the customer identifier is associated with a record in a database 21, and responsive to a determination that the customer identifier is associated with a record in the database 21, transmitting a signal from the server 20 to the particular fuel dispenser to display a message tailored to the customer associated with the customer identifier. The method may include determining whether the customer identifier is associated with a record in the database 21, and responsive to a determination that the customer identifier is associated with a record in the database 21, sending a message to the database 21 to update a customer record. Thus, for example, a record in the database 21 may contain current information on various paramaters, such as the amount of fuel purchased by the customer in the preceding month, the locations of fueling for the customer in the last year, preferences as to fuel type, information regarding responsiveness to various marketing campaigns, or other information. The parameters may be used in various reward programs, such that updated information is desirable. Thus, the updated customer record may relate to customer tracking information. Likewise, the updated customer record may relate to a stored reward value for a customer associated with the customer identifier. For example, a discount may be utilized by the customer in a transaction and the database 21 may be updated to reflect that the discount is no longer available. Alternatively, the customer may reach a threshold for a reward and the database 21 may be updated to reflect that the threshold has been reached for a subsequent transaction.

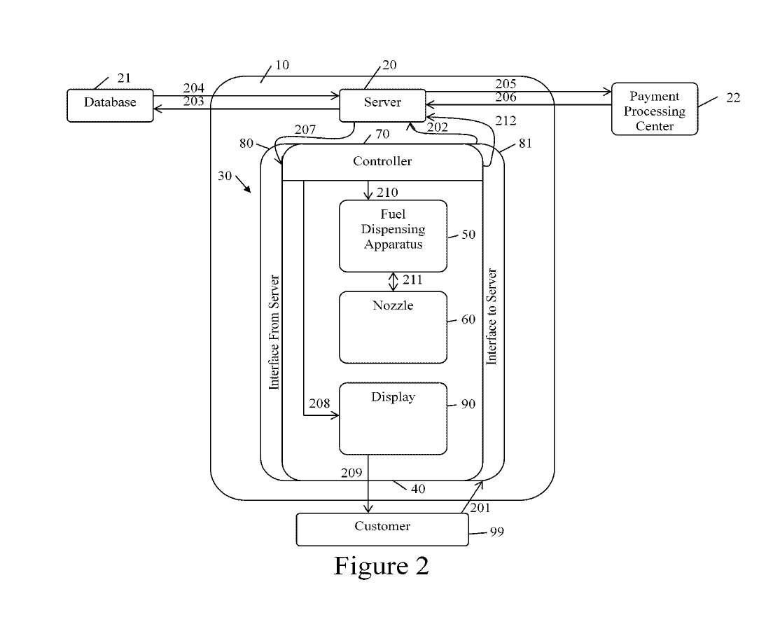

Referring to FIG. 2, a customer 99 desirous of obtaining fuel may approach the fuel dispenser 30. At step 201, the customer 99 may provide the fuel dispenser 30 with a customer identifier. The customer identifier may be any data set associated with the customer 99, including a numeric string, name, IP address, or any other identifying and unique code or reference. Examples of customer identifiers include, but are not limited to loyalty card account number, alternative identification number, phone number, registered payment card account number, etc. The customer 99 may provide the customer identifier via an interface 81 for transmitting information to the server 20. Such interface may be a keypad, barcode scanner, magnetic stripe reader, fingerprint scanner, tap and pay antenna or any other interface mounted in the housing 40 or otherwise available to the customer 99. At step 202, the fuel dispenser 30 then transmits the customer identifier, along with a fuel dispenser identifier to the server 20. The fuel dispenser identifier may be any data set associated with the fuel dispenser 30, which is unique to the fuel dispenser 30 and which can be used to verify that the customer 99 has selected the fuel dispenser 30. Some exemplary fuel dispenser identifiers include Quick Response (QR) Code, a Universal Product Code (UPC), and Global Positioning System (GPS) Coordinates. The server 20 references a database 21 at step 203 to determine whether the database 21 contains information about the customer 99. If the database 21 contains information relating to the customer identifier, the database 21 provides additional information about the customer 99 to the server 20 at step 204. Next, the customer identifier and/or the additional information about the customer 99 are transmitted from the server 20 to a payment processing center 22 at step 205. The payment processing center 22 uses the information received to determine whether the purchase of fuel by the customer 99 is approved or denied. The payment processing center 22 then transmits an indication of the approval or denial to the server 20 at step 206.

Either or both of the database 21 and the payment processing center 22 may be operated or controlled by a party other than the party operating or controlling the server. Such a third party may include a grocer partner, a social media provider, a loyalty program manager, or any other strategic partner. The server 20 may also communicate either directly or indirectly with the customer's cellular network, wholesalers, or other third parties, in addition to or instead of the database and/or the payment processing center 22 described. Likewise, while a single database 21 is described, multiple databases could be referenced by the server 20. Thus, real-time integration may occur between multiple loyalty awards services, including more than one points-based loyalty awards services. Further, communications between the server 20 and the payment processing center 22 are described as direct communications but indirect communications could accomplish the same result.

Depending on the messaging systems of the server 20, the database 21, and the payment processing center 22, the transmissions therebetween may each include an indication of customer identifier and/or additional information about the customer 99. Further, steps 205 and 206 may precede steps 203 and 204, depending on availability of the database 21 and the payment processing center 22.

Once the server 20 has received additional information about the customer 99 and/or approval or denial of the purchase of fuel by the customer 99, the server 20 may send customized information to the fuel dispenser 30 at step 207. At step 208, the controller 70 may instruct the display 90 to communicate a message to the customer. At step 209, the fuel dispenser 30 may then show a message on the display 80 or otherwise communicate with the customer 99 on the basis of the customized information. The customized information sent to the fuel dispenser 30 at step 207 may include an instruction to the fuel dispenser 30 to dispense fuel. Thus, at step 210, the controller 70 may instruct the fuel dispensing apparatus 50 to release or allow fuel to flow through nozzle 60. The nozzle 60 may communicate with the fuel dispensing apparatus 50, providing an indication of how much fuel has been dispensed or other data that might indicate that fueling should be stopped. For example, upon the tank being full, upon the customer stopping flow, or when a predetermined limit of fuel or price has been reached. If such feedback has been received, the fuel dispensing apparatus 50 may then block flow through nozzle 60. The communications between the fuel dispensing apparatus 50 and the nozzle 60 are illustrated at step 211. While illustrated as being exclusively between the nozzle 60 and the fuel dispensing apparatus 50, this step 211 may also involve communications with the controller 70 and/or the server 20. Once fueling is complete, at step 212, the controller 70 may, through the interface 81 provide feedback to the server 20 regarding any of a number of factors. For example, the fuel dispenser 30 may provide an indication of how much fuel was pumped, the type of fuel pumped, the time of pumping, whether the customer printed a receipt, or other information regarding the transaction, whether occurring before or after the server 20 last communicated with the fuel dispenser 30. The server 20 may then communicate (not illustrated) with the database 21 and/or the payment processing center 22 to reflect the information received.

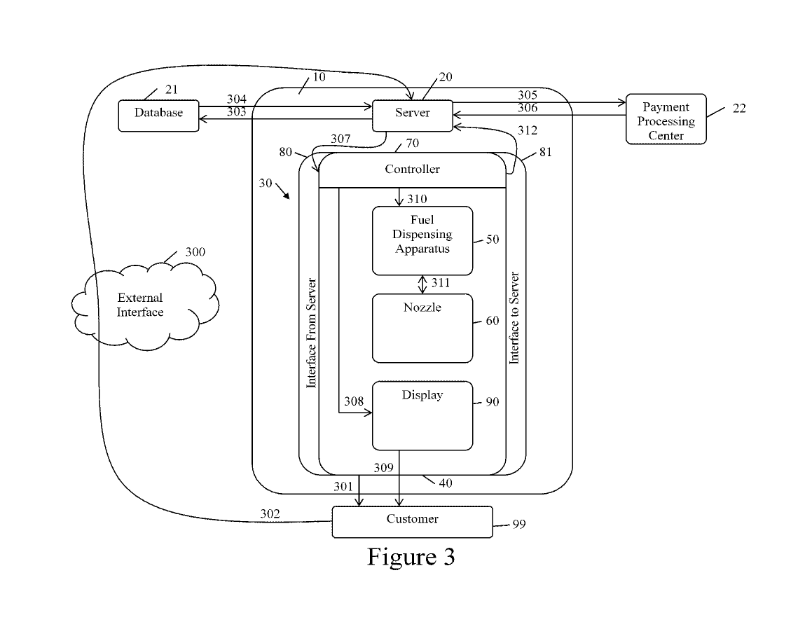

Referring now to FIG. 3, communications between the server 20 and the fuel dispenser 30 may be in a single direction, such that the server 20 transmits information directly to the fuel dispenser 30, but the fuel dispenser 30 does not transmit information directly to the server 20. In the example illustrated, the customer 99 approaches the fuel dispenser 30 as with the example of FIG. 2. However, instead of providing the customer identifier for direct transmission through an interface for transmitting information from the fuel dispenser 30 to the server 20, the customer 99 obtains, from the fuel dispenser 30, the fuel dispenser identifier at step 301. Obtaining the fuel dispenser identifier may involve scanning a code (e.g., Quick Response (QR) Code, a Universal Product Code (UPC)), capturing Global Positioning System (GPS) coordinates, mobile check in by the customer 99 to the service station or location, the use of other location based services at the service station or location, or otherwise entering a unique identifier via a handheld wireless device or otherwise. At step 302, the customer 99 sends the fuel dispenser identifier, along with the customer identifier (e.g., a cellular phone number or other identification of the customer 99 automatically provided when the customer 99 transmits the fuel dispenser identifier), through a cellular network, a nearby wireless internet connection, or other interface for indirectly transmitting information from the fuel dispenser 30 to the server 20. Thus, the fuel dispenser identifier is indirectly transmitted from the fuel dispenser 30 to the server 20. Additionally, the communication of customer identifier bypasses the fuel dispenser 30, as it is transmitted to the server 20. Steps 303 through 312 are substantially the same as steps 203 through 212 as described with respect to FIG. 2. Likewise, as with the embodiment of FIG. 2, additional communications between the server 20 and the various other elements may occur.

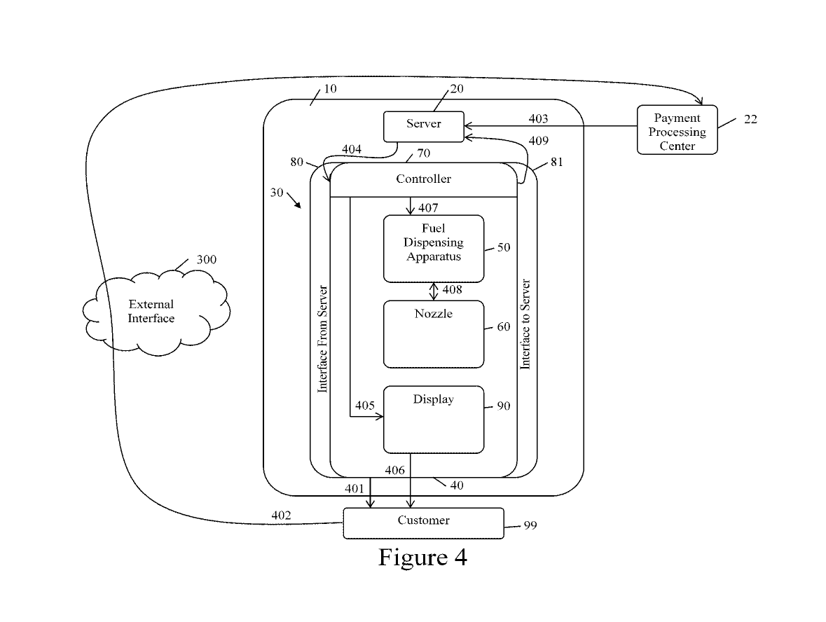

Referring now to FIG. 4, various elements of the system may be modified to provide the customer 99 with a fully tailored experience. As with FIG. 3, communications between the server 20 and the fuel dispenser 30 may be in a single direction. However, the customer 99 may purchase fuel without the server 20 ever having access to a customer identifier. As with FIG. 3, the customer 99 may obtain, from the fuel dispenser 30, the fuel dispenser identifier at step 401. At step 402, the customer 99 sends the fuel dispenser identifier, along with the customer identifier, through an external interface 300, such as a cellular network or other channel bypassing the fuel dispenser 30. However, unlike the example of FIG. 3, the customer 99 may not send the identifiers to the server 20, but may instead send the identifiers to the payment processing center 22 or to some other third party (not shown). The payment processing center 22 may use the customer identifier to determine whether the purchase of fuel by the customer 99 is approved or denied. The payment processing center 22 then transmits an indication of the approval or denial to the server 20, along with an indication of the fuel dispenser identifier at step 403. The payment processing center 22 may also transmit a transaction number or other identifier that conceals the identity of the customer 99 while allowing the transaction to proceed. Once the server 20 has received approval or denial of the purchase of fuel at the identified fuel dispenser 30, the server 20 may send customized information to the fuel dispenser 30 at step 404. With the exception of anything involving customer identification, steps 404 through 409 are substantially the same as steps 203 through 212 as described with respect to FIG. 2. Likewise, as with the embodiment of FIG. 2, additional communications between the server 20 and the various other elements may occur.

The examples of FIGS. 2-4 illustrate that the server 20 may be configured to receive information from the fuel dispenser 30, use the received information from the fuel dispenser 30 to determine whether a condition has been met, and, responsive to the determination, to transmit information to the fuel dispenser 30. For example, as illustrated in FIG. 2, the server 20 may receive information from the fuel dispenser 30, in the form of a customer identifier and fuel dispenser identifier. The server 20 may use that information to determine whether a condition has been met. Examples of conditions determined in the example of FIG. 2 include whether the transaction is approved or denied, and whether the customer identifier is associated with information in the database 21. Other examples of conditions which may be met include whether a discount is due, whether a particular fuel grade should be automatically selected, whether a reward is warranted, whether a offer should be presented, or any of a number of other parameters which may result from the association of information with the customer identifier in the database 21. Responsive to that determination, in the example of FIG. 2, the server 20 transmits customized information to the fuel dispenser 30. Customized information may include an indication of payment authorization, pricing information, discount information, preselection of fuel type, information about special offers, information about coupons, information about weather or social media, other personalized information unique to the customer 99, or any other messaging information.

Providing customized information may involve the application various algorithms to ensure that the information is accurate and that the desired customized information is conveyed. For example, if the customer 99 is entitled to two car washes as a result of a reward program, but only one car wash may be used per week, an algorithm may determine that the earlier expiring car wash should be offered to the customer 99 at the fuel dispenser. Likewise, algorithms may be used to define who, among multiple parties, is funding an offer, and thus which of different rules may apply to the offer. Customized information may be transmitted to the fuel dispenser 30 regardless of whether the server 20 directly receives the customer identifier. In fact, in some embodiments, some or all of the customized information may be independent of the customer identifier. For example, the customized information may be a mere indication of whether the transaction is approved or denied in the example of FIG. 4. Alternatively, the customized information may relate to the particular location of the fuel dispenser or other factors outside of the identity of the customer 99. Thus, if a particular service station desires to offer discount coffee before 9 am on weekends, the server 20 may send customized information relating to the discount only during the appropriate dates, days, and/or times and only to those fuel dispensers associated with that service station. Likewise, the customization may allow for the types of transactions for which an offer is valid to be readily changed by changing the algorithm at the server 20.

The server 20 may allow the ability to define how an offer is delivered to the customer 99. For example, the offer may be presented to the customer 99 as an immediate discount offered at the fuel dispenser 30, as a voucher on the receipt for the transaction, or in some other form. The customer 99 may be given the option to “opt-in” for a particular offer or type of offer. Likewise, the customer 99 may be given the option of the format of the offer (e.g., email, SMS, Mobile App, etc.).

The database 21 may include an indication of whether a particular offer is a single-use offer, a multiple use offer, or an unlimited use offer. Likewise, other parameters may be provided to allow for expiration of offers or conditions that must be met for an offer to be valid. Offers may be generated as public and/or private coupons which are printed on a receipt or otherwise distributed.

The systems, methods, and apparatus described herein may allow for the ability for the server 20 to interface with customers mobile phone to initiate a fuel purchase and receive electronic receipts to their phone, (e.g., NFC payment options, etc.). Similarly, the server 20 may communicate with social media platforms (e.g., Foursquare, Facebook, etc.) in real-time to redeem third party offers. The teachings herein may allow for the combination and/or prioritizing of offers and messages based on business rules before presenting the offers and messages to the customer 99 via the display 90. Likewise the described systems, methods, and apparatus may allow the ability to interface with the fuel dispenser 30 and get a response to generate line item discounts and to have additional messaging to appear on the display 90 when the transaction is initiated.

Customers may be identified for offers based on personal information (e.g., birthday, “likes,” buying habits, etc.) provided by the customer, or gathered from third parties. Using the systems, methods, and apparatus described, various dynamic processes can occur. For example, when a customer qualifies for multiple offers from different channels, these may all be “added” and applied to a single transaction within an agreed framework/set of rules, including any of the following: adding together all offers, partly adding offers (e.g., add offers, but only provide messaging from one offer), and logic controlled treatment of offers (e.g., contradictory offers based on onsite/offsite conditions, mutually exclusive offers, and offers which are not to be added with other offer(s)). The rules for treatment of multiple offers may be readily changed by changing the logic at the server 20. Thus, changes can readily be made to limit the number of offers a customer can receive in one transaction, to allow customers to select which offers to combine together, and/or limit the offer options presented to the customer.

Creation and management of loyalty offers from multiple sources information (loyalty transactions, customer information and transaction history) may be done by the server 20 prior to presenting a line item discount to be offered to the customer 99 at the fuel dispenser 30. Customers may be required to meet one or more onsite purchase conditions to qualify for a specific offer. For example, purchase conditions may include: purchase of fuel or diesel products, purchase of items in the service station, payment with a specific card or card type, payment with cash, payment with another particular method of payment, purchase of a specific car wash, or purchase a specific auto service. Similarly, customers may be required to meet one or more onsite non-purchase conditions to qualify for a specific offer. For example, the customer may be required to “check-in” on a mobile/web-based app, provide identification through location based services, or scan a QR code or NFC tag at the fuel dispenser 30. Additionally or alternatively, customers may be required to meet one or more offsite condition to qualify for a specific offer. Examples include shopping at a third party loyalty partner, participate in an active promotion for a targeted loyalty category, participate in an active promotion for historic purchase behavior, participate in an active promotion for attitudinal segment, participate in an active promotion for customer preferences, and engage in predefined social media interaction.

Offers managed by a wholesaler may be set up through a database or other portal accessible to the corresponding wholesaler and referenced by the server 20.

The messaging provided may be customized based on any view of the individual customer. Messaging may be sent to the fuel dispenser 30, printed on the receipt, displayed on the price pole, and/or sent to the customer's mobile device or email account. Messages may be configured to support content from a centralized owner, wholesalers, or third parties within a pre defined framework. Receipt messaging may support HTML content to be printed at the site.

Other advantages of the systems, methods, and apparatus include the ability to send a survey or other questionnaire to the fuel dispenser 30 and collect responses from customers. Likewise, data from the customer's social media profile may be used to customize the messaging. Offsite messaging may be provided to the customer in one or more of the following ways: social media, text messaging, wireless applications (smartphone), and email. The messaging framework may support a tag based system where known items like name or price can be represented by a placeholder and replaced during runtime.

The database 21 can include a profile for each customer such that identification of the customer (e.g., via customer identifier) is associated with the profile which can include information such as payment card and other account information. Payment card/account information stored in a customers profile may be used to authorize the transaction. The server 20 may request information from the database 21 and the database 21 may respond to the loyalty request with the customers payment card details to be routed for authorization to the payment processing center 22, after which the server 20 may respond to the fuel dispenser 30 with an authorization to release the fuel dispenser 30.

Based on the customers profile, steps in the transaction process may be remotely changed and/or disabled. For example, zip code prompting may be enabled/disabled, the pump authorization limit may be changed, the signature prompt may be enabled/disabled, the printing of receipts may be enabled/disabled, car wash prompts may be enabled/disabled, service station offers may be enabled/disabled, fuel grade preferences may be selected and automatically released without the need for the customer to select the grade at the fuel dispenser 30.

Any functionality may be turned on/off at any level, including at an individual site, at a wholesaler, at a location, in a state, on a date, at a time. Wholesalers may manage (create, edit, and/or delete) offers. Similarly, wholesalers may arrange sites into groups, and manage offers at the site or group level. Wholesalers may create targeted offers based on customer behavior (e.g., number of transactions, type of transactions, frequency, etc). Wholesalers may also determine the sites where offers can be earned and redeemed. The validity of offers may be controlled based on any of a number of variables, including date ranges as well as times of day. Wholesalers may view reports on activity and success of programs and rewards across sites and groups. Wholesalers may attach dynamic messages to the rewards, and/or to the site or group.

The system may access customer data such as linked loyalty accounts, linked social media accounts, and customer demographic data. A public portal may be provided, allowing customers to create and manage their profile. Additionally, customer data may be loaded from multiple external data sources. The customer may have the ability to set privacy settings around use of linked accounts.

The system may provide the ability to request multiple different loyalty offers from various third parties based on their respective interfaces. The system may provide the ability to request loyalty offers through the loyalty requests interface, and the ability to send notification of the loyalty transaction completions to third parties after a transaction has been successfully executed. The system may be able to push formatted transactions data to settlements systems and operate on either a scheduled batch or real-time operations via sftp, BizTalk or other industry standard protocol. The application may log all loyalty transactions to forward to the CRM, settlements and other external system in batch or real-time. The application may process the transaction log and batch that information to the settlements systems. The application may send formatted reporting data to a reporting system. The system may provide the ability to send notifications of transaction completions to corporate services when a transaction has been successfully executed. The system may provide the ability to send email and/or mobile receipts or messages when a transaction is completed to the consumer, based on their profile preferences.

In some embodiments, the server 20 may respond to requests from the fuel dispenser 30 within a few seconds. The response time may include the time required to interface with the database 21, the payment processing center 22, and any other third parties. Encryption may be provided for transactions of customer identifier or other customer information. However, encryption may not be necessary for data transmitted over private leased lines. Encryption requirements for business data (such as fuel dispenser identifier) may be minimal Thus, the embodiments of FIG. 4 may require minimal encryption of the server 20 and the fuel dispenser 30. In any event, where appropriate Payment Card Industry (PCI) compliance standards must be met as specified by PCI and would require PCI certification.

The application may be capable of communication with third parties using the following interfaces: XML/SOAP, BizTalk, FTP/sFTP, FileMover, TCP Sockets, PCATS. The application may be efficient in the use of processing and storage resources for (utilization during peak business, load balancing across servers, disk drives fit required growth patterns). The application may be capable of running under various hosting models, including the server 20 residing as a public cloud, a private cloud, a hosted server, or as a company datacenter. Two exemplary cloud providers include Amazon, and Azure.

The application may use mechanisms to enhance performance (e.g., caching, CDN). The server 20 may be configured to integrate with certain existing fuel dispensers 30, such as those available from Gilbarco, VeriFone, TDL, and Radiant. The application system may have the ability to integrate with multiple third party web services that provide varying levels of services (using TBD API's). The application may communicate all balance inquiries in real-time during the course of the transaction through the balance inquiries interface. Similarly, the application may communicate all loyalty requests in real-time during the course of the transaction through the loyalty requests interface. The application may communicate all loyalty completions in real-time during the conclusion of the transaction through the loyalty completions interface. The application may also communicate all issuance of the loyalty programs through the issuance interface. The application may communicate with the site point of sale (e.g., Line 24) through the point of sale specific translation layer. A batch process may parse transaction records to establish a mapping between credit card numbers and loyalty accounts. A batch process may translate loyalty rewards stored in a particular database (analytics/targeting database) into the database 21, which may be associated as or considered a loyalty reward system.

Necessary interfaces may be made available separate from the fuel dispenser 30. Likewise, logic may extend beyond loyalty and logical operations may be applied separate from loyalty logic operations. The application may be flexible, allowing for new value propositions to be introduced quickly (e.g., in less than about 3 months). The application may have the ability to process and validate local loyalty tokens in real-time from various third parties based on their respective interfaces. The application may have the ability to prioritize in real-time the various offers coming to the consumer based on their profile, and on business rules.

The system may integrate with point of sale systems via SOAP and RESTful services using TCP socket communications. The system may support abstraction of a point of sale communications layer from the core application. The system may support abstraction of third party communication layer from the core application. Finally, the system may provide full support for customer messaging through the PCATs protocol.

Those of skill in the art will appreciate that many modifications and variations are possible in terms of the disclosed embodiments, configurations, materials, and methods without departing from their scope. Accordingly, the scope of the claims and their functional equivalents should not be limited by the particular embodiments described and illustrated, as these are merely exemplary in nature and elements described separately may be optionally combined.

What is claimed is:

1. A fuel dispenser comprising:
a housing;
a fuel dispensing apparatus mounted in the housing;
a controller operatively coupled to the fuel dispensing apparatus;
a nozzle operatively coupled to the fuel dispensing apparatus and the controller; and
an interface operatively coupled to the controller and configured to receive information from a server configured to communicate directly with a plurality of fuel dispensers that are remote from one another;
wherein, responsive to information received from the server at the interface, the controller selectively permits the dispensing of fuel through the nozzle.

2. The fuel dispenser of claim 1, wherein the information from the server comprises an indication of payment authorization, pricing information, discount information, preselection of fuel type, or messaging information.

3. The fuel dispenser of claim 1, comprising a display mounted in the housing and operatively coupled to the controller.

4. The fuel dispenser of claim 3, wherein, responsive to the receipt of information from the server at the interface, a message is shown on the display.

5. The fuel dispenser of claim 1, comprising an interface for transmitting information from the fuel dispenser to the server.

6. The fuel dispenser of claim 5, wherein the information transmitted from the fuel dispenser comprises a customer identifier.

7. The fuel dispenser of claim 5, wherein the interface for transmitting information from the fuel dispenser to the server comprises a keypad, a barcode scanner, a magnetic stripe reader, a “tap and pay” antenna, other input at the fuel dispenser, or a customer's cellular network.

8. The fuel dispenser of claim 5, wherein the information from the fuel dispenser is transmitted to the server indirectly.

9. The fuel dispenser of claim 1, comprising a fuel dispenser identifier, accessible to a customer such that the customer can send information about the fuel dispenser identifier through the customer's cellular network to the server.

10. The fuel dispenser of claim 9, wherein the fuel dispenser identifier comprises a Quick Response (QR) Code, a Universal Product Code (UPC), or Global Positioning System (GPS) Coordinates.

11. The fuel dispenser of claim 1, wherein the controller is remote from the fuel dispenser.

12. The fuel dispenser of claim 11, wherein the controller is operatively coupled to a plurality of fuel dispensers.

13. A system for dispensing fuel comprising:
a fuel dispenser; and
a server configured to communicate directly with a plurality of fuel dispensers that are remote from one another;
wherein the fuel dispenser comprises:
a housing;
a fuel dispensing apparatus mounted in the housing;
a controller operatively coupled to the fuel dispensing apparatus;
a nozzle operatively coupled to the fuel dispensing apparatus and the controller; and
an interface operatively coupled to the controller and configured to receive information from the server;
wherein, responsive to information received from the server at the interface, the controller selectively permits the dispensing of fuel through the nozzle.

14. The system of claim 13, wherein the server is configured to transmit information directly to the plurality of fuel dispensers.

15. The system of claim 13, wherein the server is configured to transmit information directly to and receive information from the plurality of fuel dispensers.

16. The system of claim 13, wherein the server is configured to communicate with a third party.

17. The system of claim 13, wherein the server is remote from the fuel dispenser.

18. The system of claim 17, wherein the server is remote from each of the plurality of fuel dispensers.

19. The system of claim 13, wherein the server is configured to receive information from the fuel dispenser, to use the received information from the fuel dispenser to determine whether a condition has been met, and to transmit information responsive to the determination.

20. The system of claim 13, wherein the server is configured to communicate customized information to a particular one of the plurality of fuel dispensers, based on an identification of a customer using the particular fuel dispenser.

21. The system of claim 20, wherein the customized information comprises an indication of payment authorization, pricing information, discount information, preselection of fuel type, or messaging information.

22. A method of dispensing fuel comprising:
receiving, at a server configured to communicate directly with a plurality of fuel dispensers that are remote from one another, a message including a customer identifier and fuel dispenser identifier for a particular one of the plurality of fuel dispensers;
determining, based on the customer identifier, whether payment is approved;
responsive to a determination that payment is approved, transmitting a message from the server to the particular fuel dispenser instructing the particular fuel dispenser to dispense fuel.

23. The method of claim 22, wherein the message received at the server is transmitted by the particular fuel dispenser in response to a customer providing an indication of the customer identifier.

24. The method of claim 22, wherein the message received at the server is transmitted by a customer's cellular network in response to a customer interacting with the particular fuel dispenser.

25. The method of claim 22, wherein determining whether payment is approved comprises receiving, at the server, an indication from a payment processing center whether payment is approved.

26. The method of claim 25, wherein receiving the indication that payment is approved occurs in response to transmitting, from the server, an inquiry to the payment processing center as to whether payment is approved.

27. The method of claim 22, comprising determining whether the customer identifier is associated with a record in a database; and responsive to a determination that the customer identifier is associated with a record in the database, transmitting a signal from the server to the particular fuel dispenser to display a message tailored to a customer associated with the customer identifier.

28. The method of claim 22, comprising determining whether the customer identifier is associated with a record in a database; and responsive to a determination that the customer identifier is associated with a record in the database, sending a message to the database to update a customer record.

29. The method of claim 28, wherein the updated customer record relates to customer tracking information.

30. The method of claim 28, wherein the updated customer record relates to a stored reward value for a customer associated with the customer identifier.
